(19) United States
(12) Patent Application Publication
(10) Pub. No.: US 2004/0220954 A1
(43) Pub. Date: Nov. 4, 2004

(54) Translation of data from a hierarchical data structure to a relational data structure

(75) Inventors: Nianjun Zhou, Somers, NY (US); George A. Mihaila, White Plains, NY (US); Sriram Padmanabhan, Briarcliff Manor, NY (US); Dikran S. Meliksetian, Danbury, CT (US); Arun P. Govindarajulu, Portland, OR (US); Jessica Wu, Danbury, CT (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/425,229

(22) Filed: Apr. 29, 2003

(51) Int. Cl. G06F 17/00

(52) U.S. Cl. 707/101

(57) ABSTRACT

A system, method and computer readable medium for translating data in a hierarchical data structure to a relational data structure is disclosed. The method on an information processing system includes reading a hierarchical data abiding to a hierarchical data structure for holding data and traversing the hierarchical data structure using a tree traversal algorithm. The method further includes generating, in accordance with an external mapping script, a mapping for translating data from the hierarchical data structure to a relational data structure. The method further includes reading a hierarchical data structure including data and translating the data of the hierarchical data structure to the relational data structure using the mapping and using a depth-first traversal algorithm.

### BACKGROUND OF THE INVENTION

1. Field of the Invention

This invention generally relates to the field of data conversion and more specifically to conversion of data from a hierarchical data structure to a relational data structure.

2. Description of Related Art

The vast amount of data in modern and legacy data warehouses and on the Web poses a major challenge for those seeking to move and translate data between different formats and structures. Much information, such as data objects exchanged between different components of a web based application, or web service calls, is available in a hierarchical format, such as eXtensible Markup Language (XML). On the other hand, many contemporary and legacy databases use a relational data structure. The task of translating data in a hierarchical data structure to a relational data structure brings up several obstacles. First, it is not trivial as to “how” data in the hierarchical data structure will be arranged in a relational data structure. Second, hierarchical data can be very large, which poses a problem for solutions that call for the reading of all the source data at once. Third, data in the hierarchical data structure that is extracted can be located anywhere in the hierarchical data structure, making it difficult to locate and read. Fourth, the mapping from the hierarchical data structure should ideally be performed on the schema level instead of the instance level to reuse the mapping, which raises questions as to “how” data in the hierarchical data structure will be arranged in the relational data structure.

Therefore a need exists to overcome the problems discussed above, and particularly for a way to more efficiently translate data in hierarchical data structures to relational data structures.

### SUMMARY OF THE INVENTION

Briefly, in accordance with the present invention, disclosed is a system, method and computer readable medium for translating data in a hierarchical data structure to a relational data structure. In a preferred embodiment of the present invention, the method on an information processing system includes reading an annotated hierarchical data structure to create the mapping from the hierarchical structure to relational data structure, and use a tree traversal algorithm to shred the data into relational databases for a given hierarchical data. The method further includes generating, in accordance with the parsing step, a mapping for translating data from the hierarchical data structure to a relational data structure. The method further includes reading a hierarchical data abiding to the hierarchical data structure using a tree traversal algorithm, and translating the data of the hierarchical data structure to the relational data structure using the mapping.

In an embodiment of the present invention, both the hierarchical data structure and hierarchical data have the hierarchical formats, which can be represented by tree structures using graph theory. For example, DTD or XML schema is a hierarchical data structure, and a XML document abiding the hierarchical data structure is a hierarchical data. In addition, the tree traversal algorithm is a depth-first tree traversal algorithm.

The preferred embodiments of the present invention are advantageous, as the use of the depth-first tree traversal algorithm requires minimal memory storage during processing of the hierarchical data. This results in faster and less memory-intensive processing. In addition, the use of the depth-first tree traversal algorithm eliminates the need of back-and-forth traversals of nodes in the hierarchical data abiding to the hierarchical data structure. These back-and-forth traversal operations can be computationally expensive. Thus, the present invention results in a reduced processing burden. Lastly, the use of the depth-first tree traversal algorithm allows for a single tree traverse to complete the translation of data form the hierarchical data structure to the relational data structure. This results in a performance gain, as fewer operations are necessary.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the system architecture of a conventional database computer system.

FIG. 2 is a block diagram illustrating the overall process of one embodiment of the present invention.

FIG. 3A is a block diagram illustrating a schema of a hierarchical data structure.

FIG. 3B is a block diagram illustrating one instance of a hierarchical data structure.

FIG. 4A is a block diagram illustrating a relational data structure representing a Purchase Order (PO) table.

FIG. 4B is a block diagram illustrating a relational data structure representing a Line Item (LINEITEM) table.

FIG. 5A is a block diagram illustrating a mapping of a Purchase Order List hierarchical stricture into relational structure represented as a Purchase Order (PO) table and a Line Item (LINEITEM) table, in one embodiment of the present invention.

FIG. 5B is a block diagram illustrating a shredding tree for Purchase Order (PO) table, in one embodiment of the present invention.

FIG. 5C is a block diagram illustrating a shredding tree for Line Item (LINEITEM) table, in one embodiment of the present invention.

FIG. 6 is a flowchart depicting the overall operation and control flow of one embodiment of the present invention.

FIG. 7 is a flowchart depicting the operation and control flow of the mapping generation process according to one embodiment of the present invention.

FIG. 8 is a flowchart depicting the operation and control flow of the data translation process of one embodiment of the present invention.

FIG. 9 is a block diagram of a computer system useful for implementing the present invention.

### DESCRIPTION OF THE PREFERRED EMBODIMENTS

I. Terminology

To more clearly delineate the present invention, an effort is made throughout the specification to adhere to the following term definitions as consistently as possible.

The term “user” refers to a person interacting with a computer system.

The term “hierarchical data structure” refers to a data structure arranged in a hierarchical format, whereby elements, or nodes, of the data structure are organized in a descending or ascending hierarchy. A hierarchical data structure is typically illustrated using a descending tree structure.

The term “relational data structure” refers to a data structure arranged in a relational format, whereby elements of the data structure are arranged in rows having one of more columns. A relational data structure is typically illustrated using a table structure.

The term “mapping” refers to a system for translating data from one data structure to another data structure. A mapping can be a one-to-one mapping, a many-to-one mapping, a one-to-many mapping or a many-to-many mapping.

The term “shredding tree” refers to a data structure used to represent a mapping for translating data from a hierarchical data structure to a relational data structure.

The term “schema tree” refers to a hierarchical structure used for defining relationships between elements, or nodes, of the data structure of the hierarchical data structure and a specific table from the relational structure, and wherein no instance data is present in the schema tree.

The term “instance tree” refers to a hierarchical data abiding to a hierarchical data structure. The instance tree can be viewed as instance of the hierarchical data structure.

The term “server application” refers to a program that is located and executes on the server side of a client-server system. Examples of widely used server applications are: Common Gateway Interface (CGI) scripts, Java servlets, Hypertext Preprocessor (PHP) scripts and Perl scripts.

The term “client application” refers to a program that is located and executes on the client side of a client-server system. Examples of widely used client applications are: Java applets, servlet Java scripts and Active X controls.

II. Overview

The present invention, according to a preferred embodiment, overcomes problems with the prior art by providing an efficient and easy-to-implement method for translating data from a hierarchical data structure to a relational data structure.

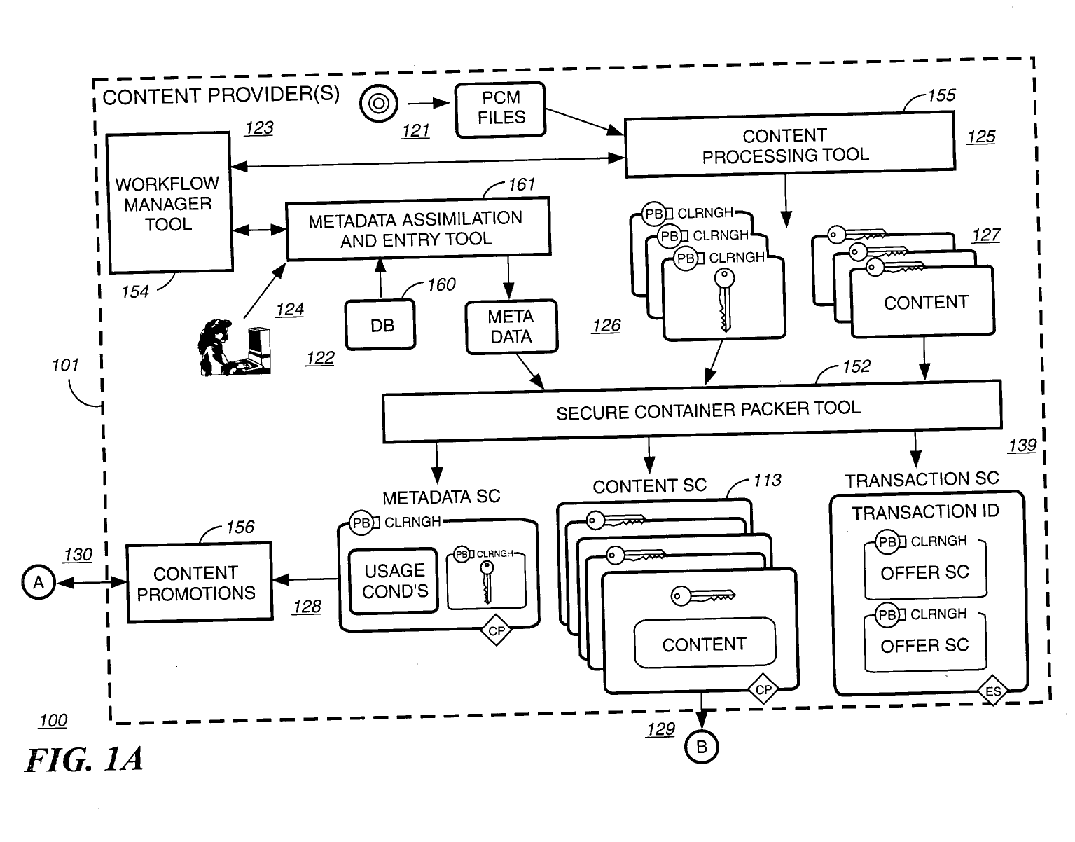

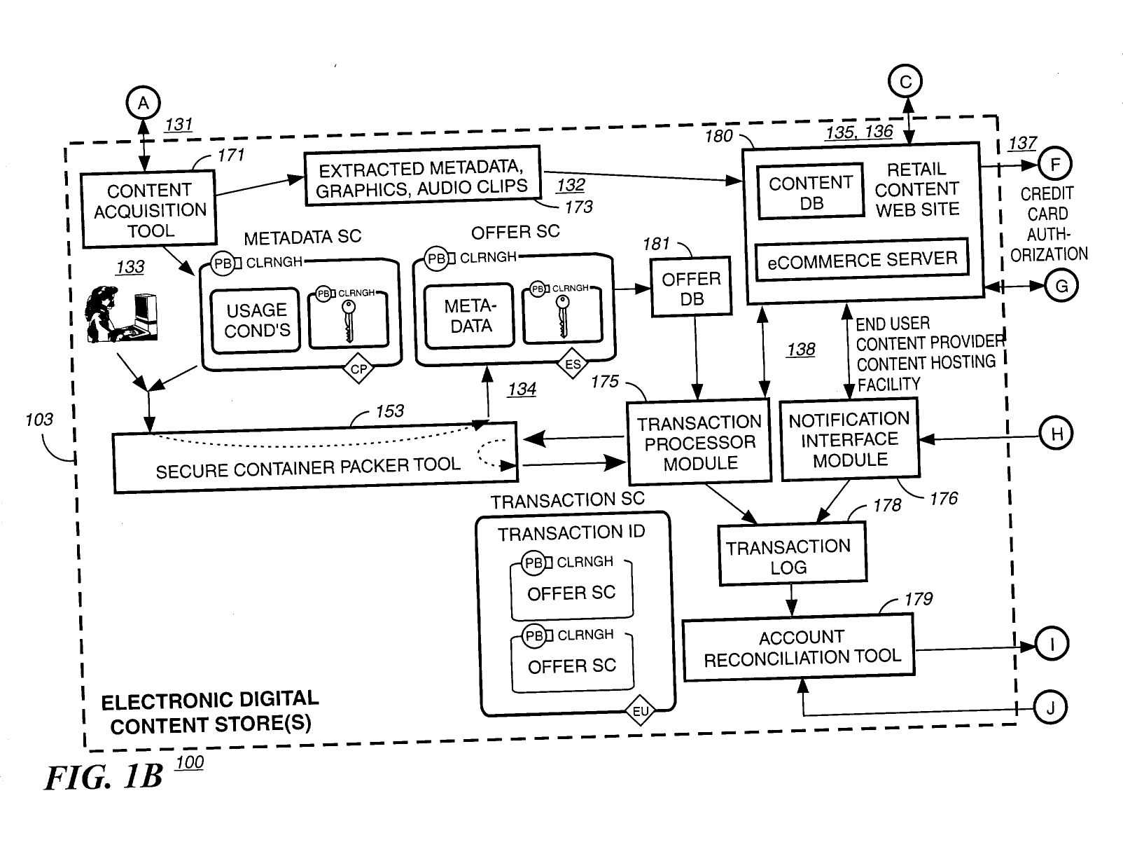

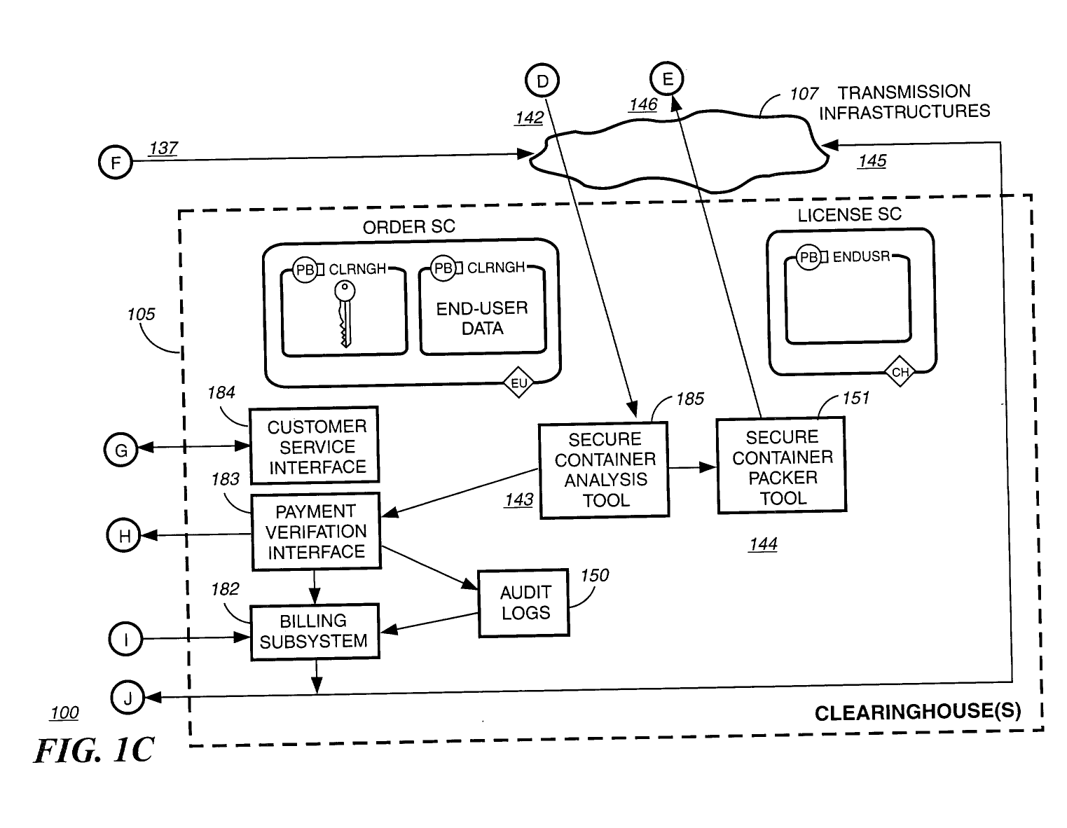

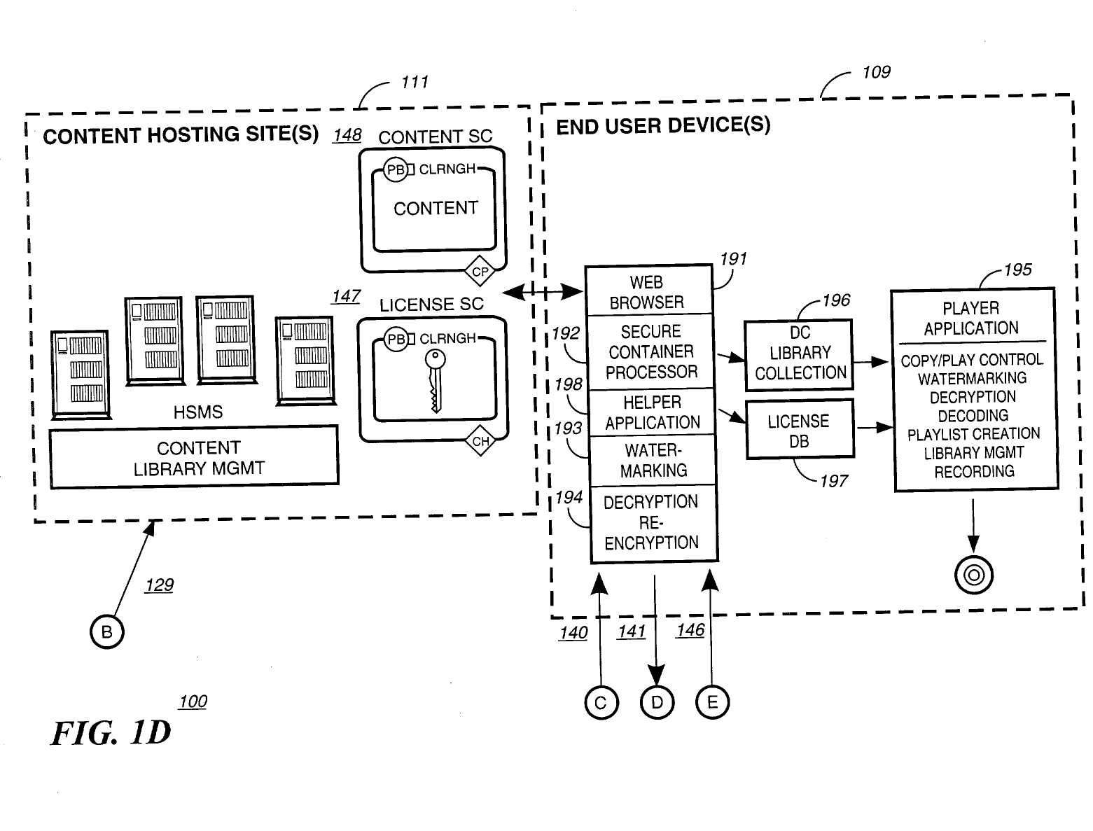

FIG. 1 is a block diagram illustrating the system architecture of a conventional database computer system. The exemplary embodiments of the present invention adhere to the system architecture of FIG. 1. A user 102, operating on a client information processing system, or client computer 104 utilizes a client application, such as a database management system (DBMS), on his client computer 104 to interact with the database 106.

In an embodiment of the present invention, the computer system of computer 104 is one or more Personal Computers (PCs) (e.g., IBM or compatible PC workstations running the Microsoft Windows 95/98/2000/ME/CE/NT/XP operating system, Macintosh computers running the Mac OS operating system, or equivalent), Personal Digital Assistants (PDAs), game consoles or any other information processing devices. In another embodiment, the computer system of computer 104 is a server system (e.g., SUN Ultra workstations running the SunOS operating system or IBM RS/6000 workstations and servers running the AIX operating system).

In another embodiment of the present invention, the database 106 is a part of the computer system of computer 104. In yet another embodiment of the present invention, the database 106 is a part of a computer system (such as a server system) separate from computer 104 (a client system). In this embodiment, the computer 104 communicates with the computer system of database 106 over a network or other communication medium.

In yet another embodiment of the present invention, an optional network connects computer 104 and database 106. In one embodiment, the network is a circuit switched network, such as the Public Service Telephone Network (PSTN). In another embodiment, the network is a packet switched network. The packet switched network is a wide area network (WAN), such as the global Internet, a private WAN, a local area network (LAN), a telecommunications network or any combination of the above-mentioned networks. In yet another embodiment, the network is a wired network, a wireless network, a broadcast network or a point-to-point network.

In an embodiment where the database 106 is a part of a server computer system separate from client computer 104, certain data translation tasks at client computer 104 are performed by a client application, such as a Java applet, a Java scriptlet, Java script, Perl script, an Active X control or any self-sufficient application executing on the computer system of computer 104. Further, certain data translation tasks at the server system of database 106 are performed by a server application such as a Common Gateway Interface (CGI) script, a Java servlet, a Hypertext Preprocessor (PHP) script, a Perl script or any self-sufficient application executing on the server system of database 106.

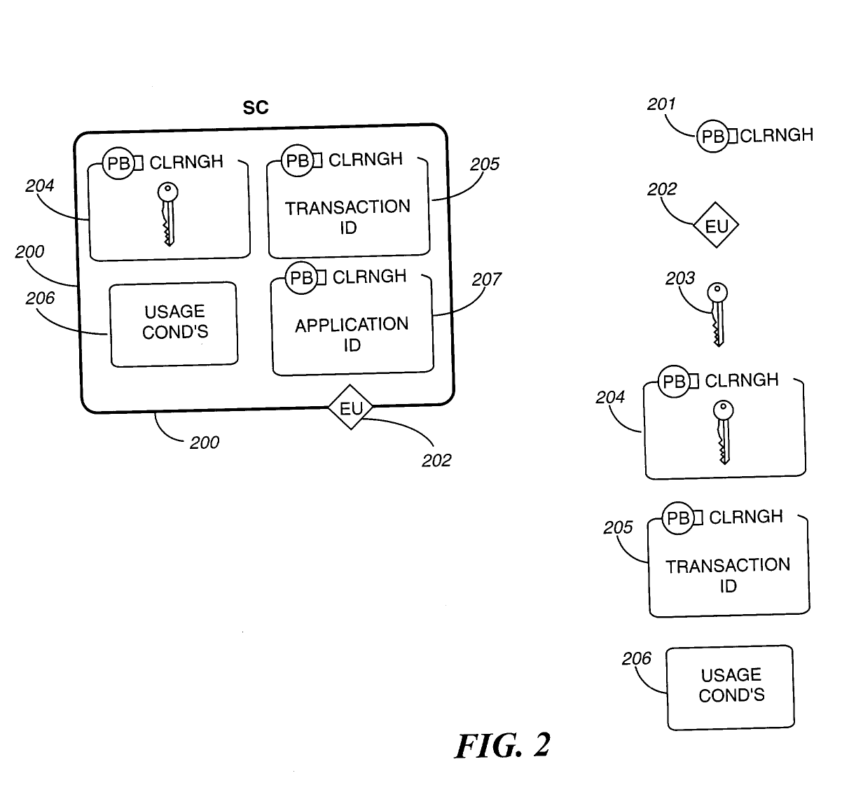

FIG. 2 is a block diagram illustrating the overall process of one embodiment of the present invention. FIG. 2 shows a converter 202 representing an application or other process for performing the main process of the present invention—the translation of data from a hierarchical data structure to a relational data structure. FIG. 2 also shows a hierarchical data structure 203 and a relational data structure 204. A mapping 205 is utilized by the converter 202 to specify how the data from a hierarchical data structure 203 is translated to the relational data structure 204. A mapping is a system for translating data from one data structure to another data structure. A mapping can be a one-to-one mapping, a many-to-one mapping, a one-to-many mapping or a many-to-many mapping. The process of translating the data from a hierarchical data structure 203 to the relational data structure 204 is described in greater detail below.

In one embodiment of the present invention, the hierarchical data structure 203 and the relational data structure. 204 reside on one or more databases, such as database 106. As such, a user 102 initiates a converter 202 executing on a client computer, such as computer 104, for translating the data from a hierarchical data structure 203 to the relational data structure 204.

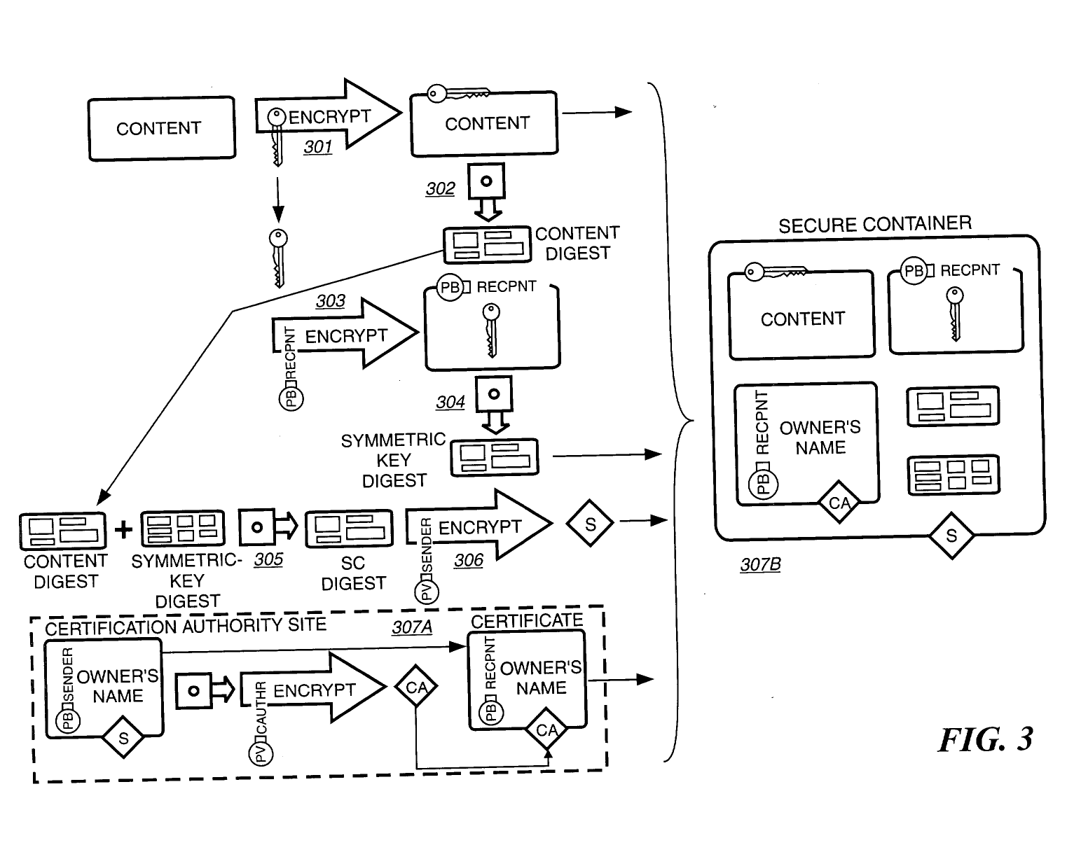

FIG. 3A is a block diagram illustrating a schema of a hierarchical data structure 350, i.e., a schema tree. The hierarchical data structure 350 is a data structure arranged in a hierarchical format, whereby nodes of the data structure are organized in a descending hierarchy. The hierarchical data structure 350 is illustrated using a descending tree structure.

The hierarchical data structure 350 represents an exemplary purchase order list 352 as is typically used by a business or individual desiring to purchase a list of products, goods or services from a vendor or seller. The purchase order list 352 contains a list of purchase orders such as purchase order 354. Each purchase order 354 further contains a purchase order identifier 358, a buyer 360, a seller 362, and a list of line items, such as line item 364. A line item further contains a name 374 and a price 376.

Note that hierarchical data structure 350 comprises a plurality of nodes. Each node is either a group node or a data node. A group node points to one or more other nodes—designated by a circular shape in FIG. 3A. A group node is also associated with a label, typically designating the type of nodes to which the group node points. For example, nodes 352, 354, 358, 360, 362, 364, 374 and 376 are group nodes as each of these nodes points to one of more other nodes. A data node holds actual data pertaining to the node—shown in more detail in FIG. 3B. All nodes are associated with a node identifier that uniquely identifies the node.

FIG. 3B is a block diagram illustrating one instance of a hierarchical data structure 300, i.e., an instance tree. The hierarchical data structure 300 is one instance of the schema tree, i.e., hierarchical data structure 350, illustrated using a descending tree structure.

The hierarchical data structure 300 represents an exemplary purchase order list 302 as is typically used by a business or individual desiring to purchase a list of products, goods or services from a vendor or seller. The purchase order list 302 contains a list of purchase orders such as purchase orders 304 and 306. Each purchase order 304 or 306 further contains a purchase order identifier 308, a buyer 310, a seller 312, and a list of line items, such as line item 314. A line item further contains a name 324 and a price 326.

As explained above, each node in hierarchical data structure 300 is either a group node or a data node. A group node points to one or more other nodes—designated by a circular shape in FIG. 3B. A group node is also associated with a label, typically designating the type of nodes to which the group node points. A data node holds actual data pertaining to the node—designated by a rectangular shape in FIG. 3B. For example, nodes 302, 304, 306, 308, 310, 312, 314, 324 and 326 are group nodes as each of these nodes points to one of more other nodes. Nodes 318, 320, 322, 328 and 330 are data nodes as each of these nodes contains data pertaining to the instant node. It should be noted that although the instance hierarchical data structure 300 shows only two purchase orders 304 and 306 and only one line item 314, this is shown by way of example only and an instance of the hierarchical data structure 300 supports any number of purchase orders and/or line items. In fact, any group node in an instance of the hierarchical data structure 300 supports any number of child nodes.

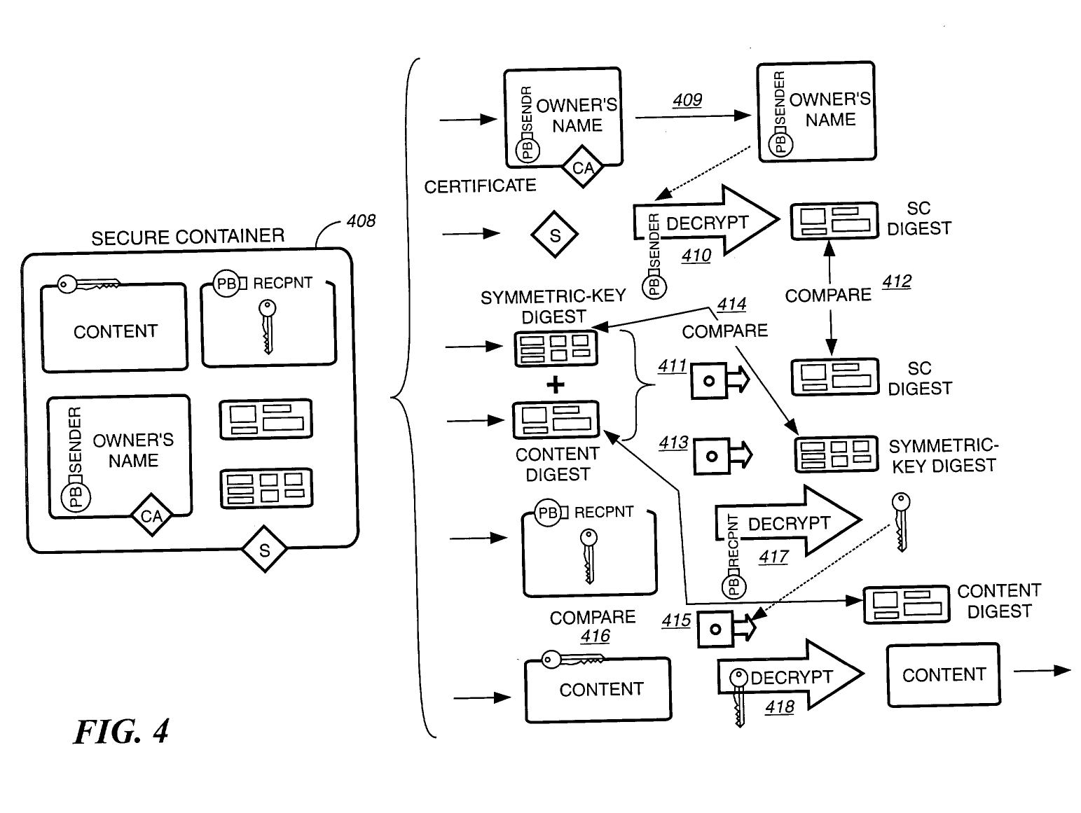

FIGS. 4A and 4B are block diagrams illustrating relational data structures arranged in a relational format, whereby elements of the relational data structure are arranged in multiple rows having one of more columns. The relational data structure is illustrated using a table structure. Each relational data structure comprises a table having at least one column. Each table can contain many tuples of data elements in the table.

FIG. 4A is a block diagram illustrating a relational data structure 402 representing a Purchase Order (PO) table. A table consists of one or more rows, such as row 408. A row is a group of data values, conceptually arranged horizontally in columns, as shown in FIG. 4A. The relational data structure 402 represents an exemplary purchase order, as described in with reference to FIG. 3A and FIG. 3B above. The purchase order contains a purchase order identifier 418 (in a first column of the row 408), a buyer 420 (in a second column of the row 408) and a seller 422(in a third column of the row 408). Each PO has one ore more Line Items (or items for purchase) associated with it. This is described with reference to FIG. 4B below.

FIG. 4B is a block diagram illustrating a relational data structure 404 representing a Line Item (LINEITEM ) table. The table consists of rows 410 and 412. A row is a group of data values, conceptually arranged horizontally in columns, as shown in FIG. 4B. The relational data structure 404 represents an exemplary Line Item list, as described in with reference to FIG. 3A and FIG. 3B above. The Line Item list comprises two Line Items. The first Line Item is a notebook in the second column 430 of row 410. The notebook Line Item is identified by a Purchase Order Id in the first column 428 of the row 410. The notebook is further described by its associated price in the third column 432 of the row 410. The second Line Item is a sleeping bag in the second column 430 of row 412. The sleeping bag Line Item is identified by a Purchase Order Id in the first column 428 of the row 412. The sleeping bag is further described by its associated price in the third column 432 of the row 412.

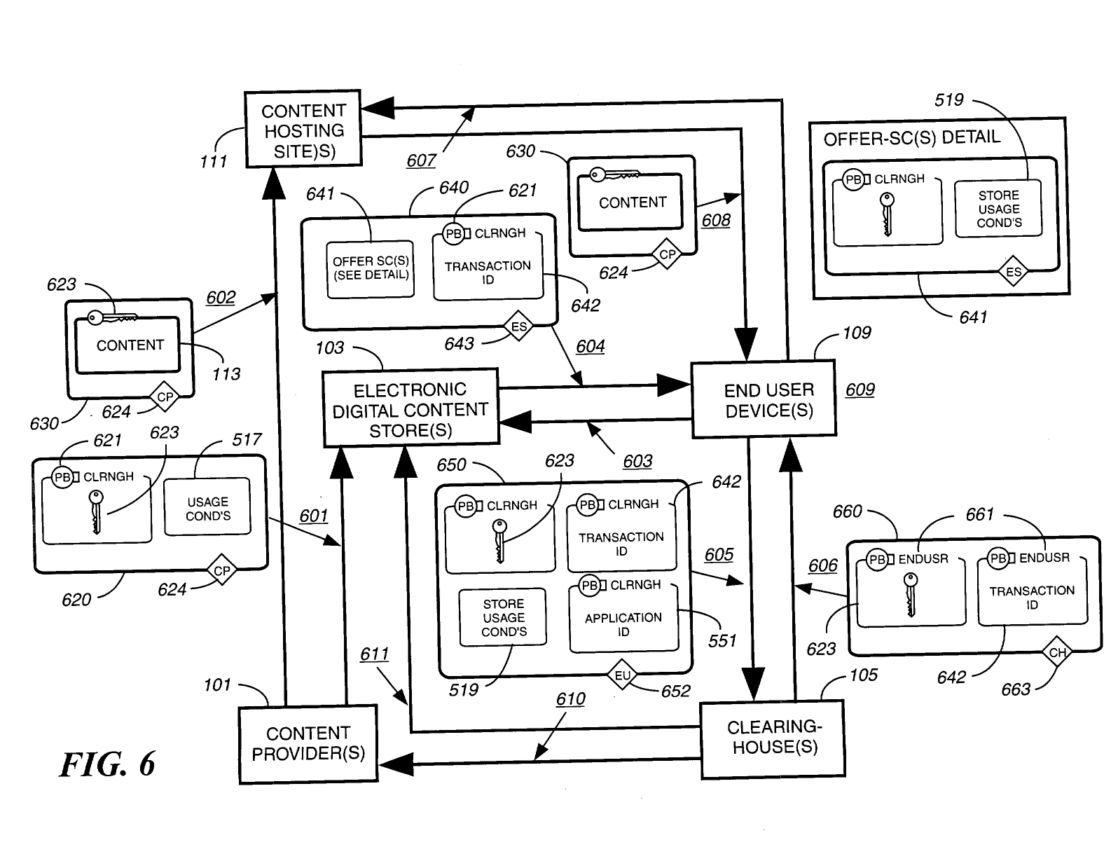

FIG. 6 is a flowchart depicting the overall operation and control flow of one embodiment of the present invention. The operation and control flow of FIG. 6 depicts the translation of data from a hierarchical data structure 203 to a relational data structure 204 using a mapping 205. The operation and control flow of FIG. 6 begins with step 602 and proceeds directly to step 604.

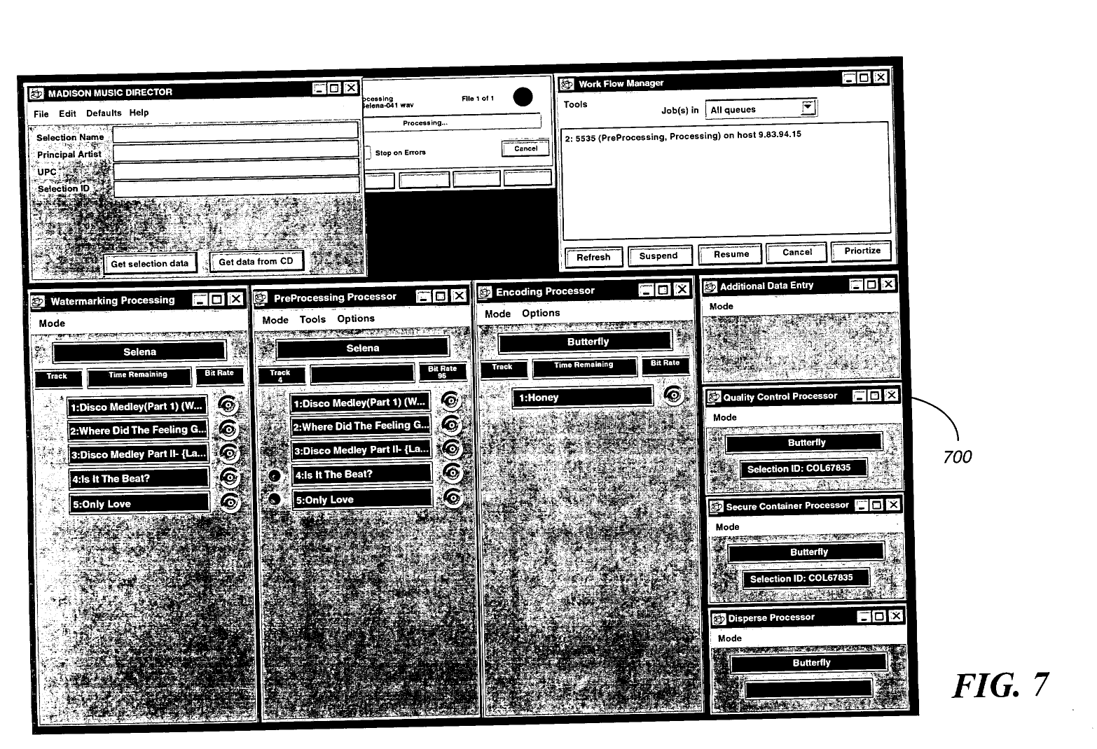

In step 604, a source hierarchical data structure, i.e., a schema tree such as described with reference to FIG. 3A, is read. This step comprises reading an external transformation script. Next, in step 606, a mapping for the translation of data from a hierarchical data structure 203 to a relational data structure 204 is generated based on the source hierarchical data structure read in step 602. This process is described in greater detail below with reference to FIG. 7. As a result, the converter 202 is prepared for the translation of data from a hierarchical data structure 203 to a relational data structure 204.

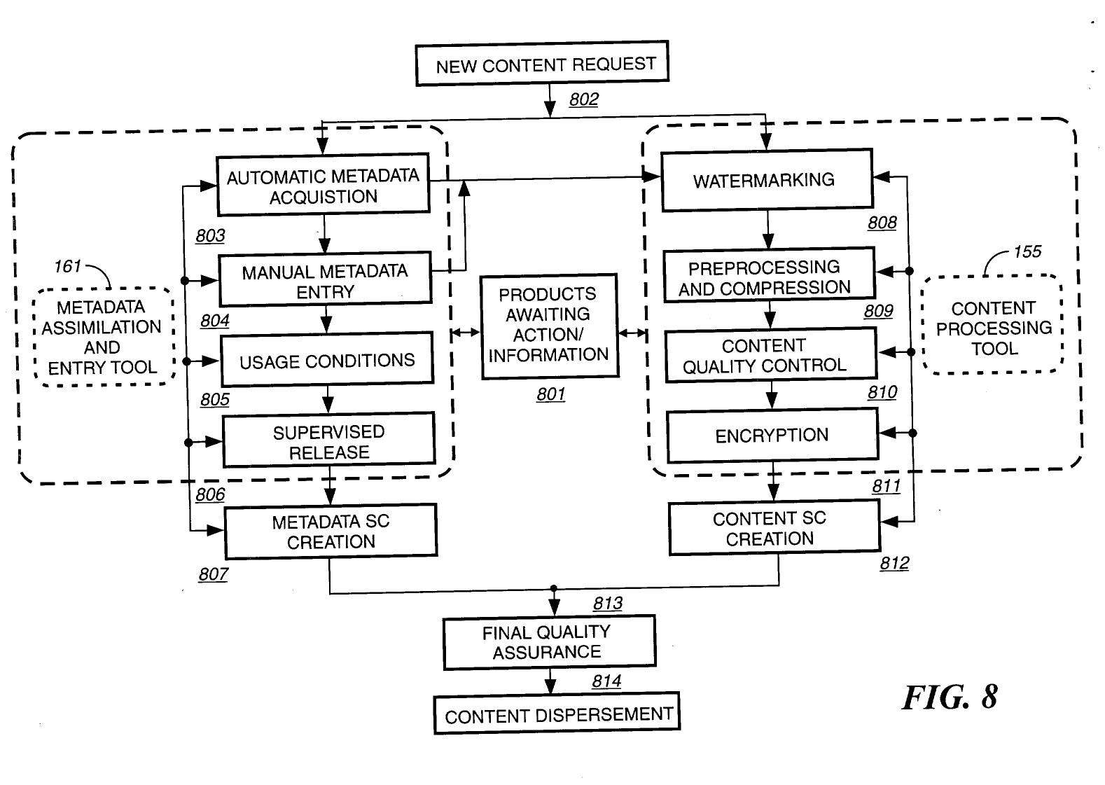

Subsequently, in step 608, hierarchical data abiding to the hierarchical data structure, such as hierarchical data structure 300 of FIG. 3B, is read by the converter 202. In step 610, the converter 202 translates the data from the hierarchical data structure 300 to a relational data structure 204. This process is described in greater detail below with reference to FIG. 8. Finally, in step 612, the control flow of FIG. 6 stops.

III. Mapping

FIG. 7 is a flowchart depicting the operation and control flow of the mapping generation process according to one embodiment of the present invention. The operation and control flow of FIG. 7 depicts the process of generating a mapping 205 from an external mapping specification. The operation and control flow of FIG. 7 provides further detail of the step 606 of FIG. 6, wherein a mapping for the translation of data from a hierarchical data structure 203 to a relational data structure 204 is generated based on the source mapping script. The operation and control flow of FIG. 7 begins with step 702 and proceeds directly to step 704.

In step 704, the input mapping script, such as a DTDSA script, is read. In addition, the type of the script is specified. In step 706, the input mapping script is parsed. This step depends on the syntax and format of the mapping script. In step 708, the mapping 205, otherwise known as a shredding tree, is created. The shredding tree consists of the stored sequence of the traversal of the nodes of the schema tree. In step 710, the control flow of FIG. 7 stops.

As explained above, a shredding tree refers to a data mapping for translating data from a hierarchical data structure to a specific table of a relational data structure. A mapping from a hierarchical data structure to a relational data structure consists of one to more shredding trees. A shredding tree comprises two types of nodes: cursor nodes and data nodes. All of the nodes of the shredding tree are labeled with hierarchical, or node, locators. A node locator is a path expression obtained by concatenating the labels of the group nodes from the root of the schema tree to a node in the schema tree (which was traversed in step 706). Each shredding tree has a local lookup table, which maps a node locator to its corresponding shredding tree node. A node locator can either correspond to a cursor node or a data node in a shredding tree, but not both.

Cursor nodes adhere to a group of requirements. First, each shredding tree has one or more cursor nodes. In addition, cursor nodes are totally ordered by their node locators (in lexicographic order of the path expressions). Also, cursor nodes are non-leaf nodes. A cursor node can have at most one child cursor node but must have at least one child data node. Each cursor node corresponds to a loop in the shredding algorithm. Finally, at run time, each cursor node owns a non-negative integer called a cursor. The cursor will be used to point to a specific tuple in a list of data tuples during the execution of the tree traversal algorithm for a hierarchical data.

Similarly, data nodes adhere to a group of requirements. Each shredding tree has one or more data nodes and each data node corresponds to a column of the corresponding relational data structure. In addition, data nodes are leaf nodes and each data node will inherit the cursor value of its parent cursor node.

In an embodiment where extensible Markup Language (XML) is translated to a Relational Data Base Management System (RDBMS), a cursor node must point to an XML element. Cursor nodes are totally ordered by the XPath as string. Data nodes only point to XML attribute nodes or text nodes of an XML schema tree. The embodiment where XML is translated to a RDBMS is described in greater detail below.

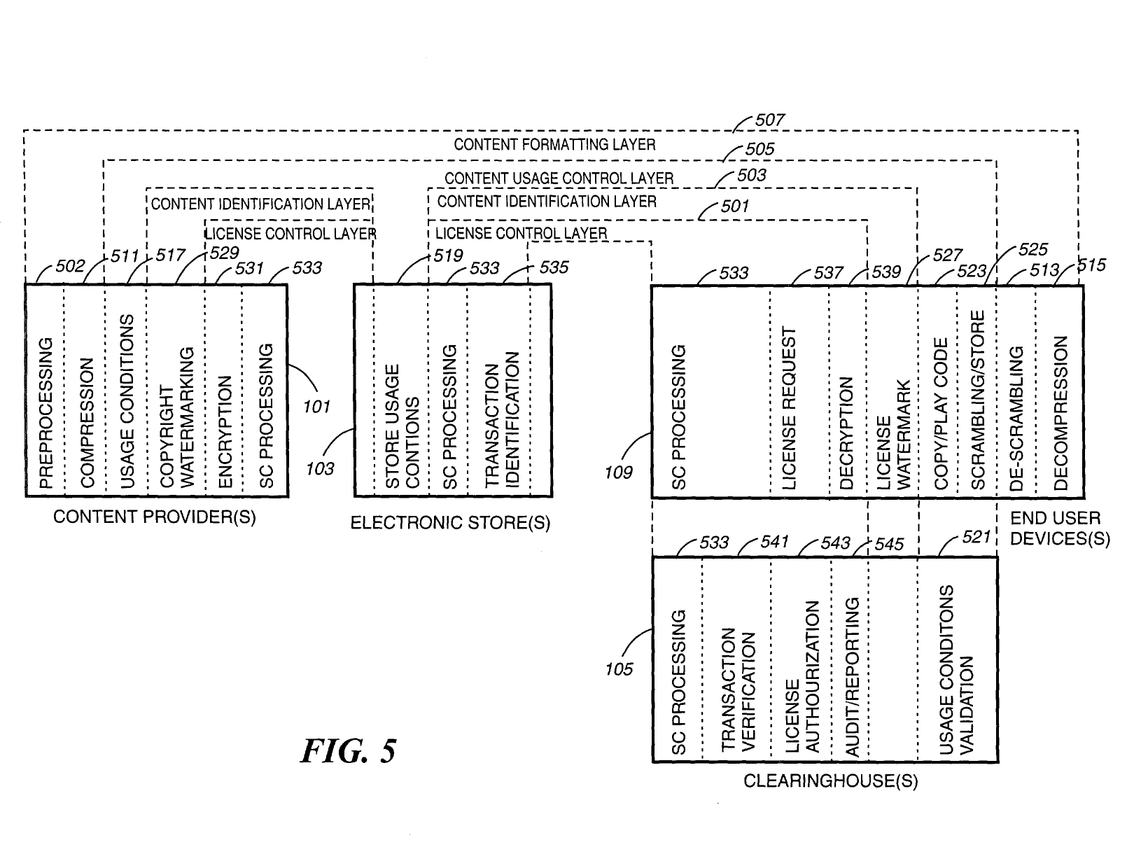

FIG. 5A is a block diagram illustrating a mapping of a Purchase Order List into a PO table and a Line Item table, in one embodiment of the present invention. FIG. 5A shows the hierarchical data structure 350, which is then mapped to the relational data structure Purchase Order (PO )table 402 (as shown in FIG. 4A) and to the relational data structure Line Item (LINEITEM) table 404 (as shown in FIG. 4B). The manner in which data is mapped from one structure to the others is described in greater detail below.

FIG. 5B is a block diagram illustrating a shredding tree 502 of a Purchase Order data structure, in one embodiment of the present invention. The shredding tree 502 was generated via the mapping generation process using a external mapping specification, as described in greater detail above with reference to FIG. 7.

Upon commencement of the traversal algorithm, the first cursor node 504 (consisting of the node locator “/polist/po”) is created, representing the root of the shredding tree 502. Next, the leftmost branch of the schema tree 350 is traversed, resulting in the shredding node 506, consisting of the node locator “/polist/po/id/text( )”. Next, the second most leftmost branch of the schema tree 350 is traversed, resulting in the shredding node 508, consisting of the node locator “/polist/po/buyer/text( )”. Next, the third leftmost branch of the schema tree 350 is traversed, resulting in the shredding node 510, consisting of the node locator“/polist/po/seller/text( )” . Note that nodes 506, 508 and 510 are data nodes since each may contain date associated with that node. For example, node 506 is associated with data “Purchase Order Id,” node 508 is associated with data “Buyer Name,” and node 510 is associated with data “Seller Name.”

FIG. 5B shows that the data of node 506 maps to column 418 of PO table 402. FIG. 5B also shows that the data of node 508 maps to column 420 of PO table 402 and that the data of node 510 maps to column 422 of PO table 402.

FIG. 5C is a block diagram illustrating a shredding tree 512 of a Line Item data structure, in one embodiment of the present invention. The shredding tree 512 was generated via the mapping generation process using a external mapping specification, as described in greater detail above with reference to FIG. 7.

Upon commencement of the external script parsing (such as DTDSA parsing), the first cursor node 514 (consisting of the node locator “/polist/po”) is created, representing the root of the shredding tree 512. Next, the leftmost branch of the schema tree 350 is traversed, resulting in the shredding node 516, consisting of the node locator “/polist/o/id/text( )”. Next, the fourth most leftmost branch of the schema tree 350 is traversed up to a cursor node, resulting in the cursor node 518, consisting of the node locator “/polist/po/lineitem.” Next, the fourth most leftmost branch of the schema tree 350 is further traversed, resulting in the shredding node 520, consisting of the node locator “/polist/po/lineitem/name/text( )”. Finally, the fifth most leftmost branch of the schema tree 350 is traversed, resulting in the shredding node 522, consisting of the node locator “/polist/po/lineitem/price/text( )”. Note that nodes 516, 520 and 522 are data nodes since each may contain date associated with that node. For example, node 520 is associated with data “Name,” and node 522 is associated with data “Price.”

FIG. 5C shows that the data of node 516 maps to column 428 of Line Item table (LINEITEM) 404. FIG. 5C also shows that the data of node 520 maps to column 430 of Line Item table 404 and that the data of node 522 maps to column 432 of Line Item table 404.

A. Exemplary Mapping

The structure of XML documents is usually specified by means of document type definitions (DTD), or XML Schema documents. In order to specify the mapping between a hierarchical document structure and a relational data structure, a notation is needed to indicate the relationship between XML nodes (elements or attributes) and columns a relational data structure. One possible solution is an extension to the DTD notation, called DTDSA (document type definition with source annotations). DTDSA can be used for the purpose of defining XML views over a relational data structure, whereas here it is used as a mapping definition language for the opposite data conversion: from XML to a relational data structure.

The DTDSA notation is illustrated through an example. Consider the following DTD that specifies the structure of an XML document containing a list of purchase orders:

<!ELEMENT Ipo (po*)>

<!ELEMENT po (id, buyer, seller, lineitem*)>

<!ELEMENT id #PCDATA>

<!ELEMENT buyer #PCDATA>

<!ELEMENT seller #PCDATA>

<!ELEMENT lineitem (name, price)>

<!ELEMENT name #PCDATA>

<!ELEMENT price #PCDATA>

Further, consider the following relational data structure:

PO(ID, BUYERNAME, SELLERNAME)

LI(POID, ITEM, PRICE)

The above DTD is annotated with processing instructions that indicate for each leaf element (#PCDATA) the table and column name where it should be stored as follows:

<!ELEMENT Ipo (po*::x:=row(PO))>

<!ELEMENT po (id, buyer, seller, lineitem*

::y:=row(LI, <POID>, <x.ID>)>

<!ELEMENT id #PCDATA:x.ID>

<!ELEMENT buyer #PCDATA:x.BUYERNAME>

<!ELEMENT seller #PCDATA:x.SELLERNAME>

<!ELEMENT lineitem (name, price)>

<!ELEMENT name #PCDATA:y.ITEM>

<!ELEMENT price #PCDATA:y.PRICE>

The above DTDSA is obtained as follows:

1) For every element for which there is a repetition symbol (*), a variable is introduced and it is bounded to a table name with a row( ) annotation (called binding annotation). There are two types of row( ) annotations: a) with a single argument, it just specifies the table, b) with three arguments, it specifies a table, a list of columns of that table, and a list of values for those columns (for example, the annotation for variable y specifies that the value of column POID is equal to the value of the ID column of the current x tuple.

2) For every leaf element, an expression is specified of the form variable.column, where the variable was previously bound to a table, and the column belongs to that table.

A DTDSA specification is translated to a set of shredding trees, one tree for each table, as follows:

1) A DTDSA parser converts the DTDSA file into an equivalent directed graph representation: for every ELEMENT definition, a node labeled with the element name is created; every time an element name a is mentioned in the definition of another element b, a directed edge is drawn from node b to node a; if the element a has a repetition symbol, the edge is marked with a star symbol; also, the annotations are attached as follows: the binding annotations are attached to their corresponding star edges, and the value annotations are attached to the leaf nodes they annotate; in addition, the three argument row( ) annotations will also generate value annotations for every column mentioned in the second argument which will be attached to the same leaf nodes as their corresponding values from the third argument: for example, the annotation for variable y will generate a value annotation y.POID which will be attached to the leaf node id.

2) For every table, or equivalently, for every defined variable v, the directed graph obtained in the previous step is traversed from the root, and the current path from the root to the current node is maintained (for example, /Ipo/po/lineitem is the path from the root node Ipo to lineitem). The shredding tree for the current table is constructed as follows:

(a) Every time a binding annotation is encountered, a cursor node is created and labeled with the current path;

(b) Every time a value annotation containing the variable of interest v is encountered, a value node is created and labeled with the path expression obtained by appending the string “/text( )” to the current path;

(c) Every time a node n is created (with the exception of the first node), it is attached as a child to the cursor node whose label constitutes the longest prefix into n's label

(d) As a last step, the shredding tree is pruned, by eliminating all cursor nodes that are not on a path from the root to a value node (these nodes are irrelevant for the current table).

As an alternative notation, one can use annotated XML Schema documents. The XML Schema standard allows for application specific annotations inside the <appinfo> tags. The same syntax for binding and value annotations can be used inside an XML Schema document (in the <appinfo> tags of the respective element definitions).

Above, a specification language was presented for the definition of mappings from XML to relational schema. This specification by itself does not allow the user to indicate the update action to be applied against the relational data. In this section, one such action specification is introduced using the XML notation.

For every relational table that is specified in the DTDSA file, the user can provide an SQL update statement (either INSERT, UPDATE, or DELETE). This is illustrated using an example. Consider the following “actions.xml” file:

<xi>

<action variable = “x”>
UPDATE PO
SET BUYERNAME = x.BUYERNAME
WHERE ID = x.ID

</action>
<action variable = y”>

INSERT INTO LI (POID, ITEM, PRICE)
VALUES (x.POID, x.ITEM, x.PRICE)

</action>

</xi>

The above file refers to the variable names defined in the DTDSA file (from the previous section), and specifies, for each variable, the specific operation to be executed. The parameterized SQL data modification statements will be instantiated by the runtime engine by replacing the variable.COLUMN expressions with the values of the indicated columns of the tuples obtained by the shredding algorithm and issued to the RDBMS.

In the common case where all actions are INSERTS, the file “actions.xml” is not mandatory: if an action file is not specified, the runtime engine will assume an INSERT behavior is intended and generate the appropriate INSERT statements.

IV. Translation

FIG. 8 is a flowchart depicting the operation and control flow of the data translation process of one embodiment of the present invention. The operation and control flow of FIG. 8 depicts the process of translating data in a hierarchical data structure 203 to a relational data structure 204 using a mapping 205 from a schema tree, such as shown in FIG. 3A, to a relational data structure 204. The operation and control flow of FIG. 8 provides further detail of the step 610 of FIG. 6, wherein data is translated from a hierarchical data structure 203 to a relational data structure 204 based on a mapping 205 generated in step 606. The operation and control flow of FIG. 8 begins with step 802 and proceeds directly to step 804.

In step 804, the mapping 205, or shredding trees 502 and 512, is utilized to traverse through the nodes of an instance of a hierarchical data structure. As described above, each node of the shredding trees 502 and 512 corresponds to a node of the instance of the hierarchical data structure. In this Way, the shredding trees 502 and 512 specify the manner in which to traverse through the nodes of the instance of a hierarchical data structure. Note the shredding trees 502 and 512 can be generated from the external mapping script (such DTDSA script) through a script parser, or can be generated manually.

Thus, the shredding trees 502 and 512 specify the manner in which to traverse through the nodes of the instance of the hierarchical data structure consistent with the tree traversal algorithm used to generate the shredding trees 502 and 512.

Next, in step 806, the data in each node of the instance of the hierarchical data structure is read. In step 808, the source hierarchical data is shredded, or extracted, and written to the corresponding location in the target relational data tables. This is explained in greater detail below. In step 810, the control flow of FIG. 8 stops.

In one embodiment of the present invention, the traversal of the instance of the hierarchical data structure consists of a single depth-first tree walk of the structure—the instance tree. First, the algorithm loops through all the shredding trees, and creates an empty set object for each shredding tree: this is referred to as the master data set. Second, a depth-first tree traversal of the instance tree is performed. For each node of the hierarchical data tree, the node locator is stored. From the global lookup table, the corresponding shredding tree is determined based on the node locator. For the node locator, the algorithm loops through all of the shredding trees corresponding to the instant node locator.

When a node is first entered for traversal, for a given shredding tree, if the node locator corresponds to a cursor node, the resulting actions are:

1. If the cursor node points to the outermost cursor, a new data set is created (referred to as the current data set). The outermost cursor is the cursor owned by the root node of the shredding tree. A new temporary empty tuple is created.

2. For any cursor node, its cursor will point to the current tuple of the data set.

3. For the current data set, when the innermost cursor node is encountered, a new tuple is created and the data from the temporary tuple is copied into the new tuple. This new tuple is referred to as the current tuple. The innermost cursor node is the cursor node that has the largest depth.

When a node is first entered for traversal, for a given shredding tree, if the node locator corresponds to a data node, the resulting actions are:

1. Acquire the parent node, which is a cursor node.

2. Find the row of the data set pointed by the current cursor node. This row will is referred to as the start row.

3. Acquire the cursor node that is the parent node of the data node.

4. Insert data into the column of each tuple from the tuple pointed by the cursor node and to the current tuple.

When a node is first exited for traversal, for a given shredding tree, if the node locator corresponds to a cursor node, the resulting actions are:

1. Identify all the child data nodes of the cursor node.

2. Acquire all the columns associated with of these data nodes.

3. Copy the current tuple into a temporary tuple.

4. For this temporary tuple, set values of all the columns as nulls.

5. If the cursor is the outermost cursor, move the current data set into the master data set of the shredding tree.

It should be noted that the tree traversal algorithm explained above results in an efficient traversal of the instance tree. The tree traversal is performed in N steps, where N is the number of nodes in the instance tree (or data tree). For each node of the instance tree, there is at most one row that is generated in each of the M tables, where M is the number of tables. The cost of generating one row is bounded by the maximum number of columns K, where K is the maximum number of columns in each table. Therefore the total cost is proportional to N*M*K, that is, linear in the size of the data tree, O(N).

V. Exemplary Implementations

The present invention can be realized in hardware, software, or a combination of hardware and software in computer 104 or the computer system of database 106 of FIG. 1. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product (in computer 104 or the computer system of database 106), which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

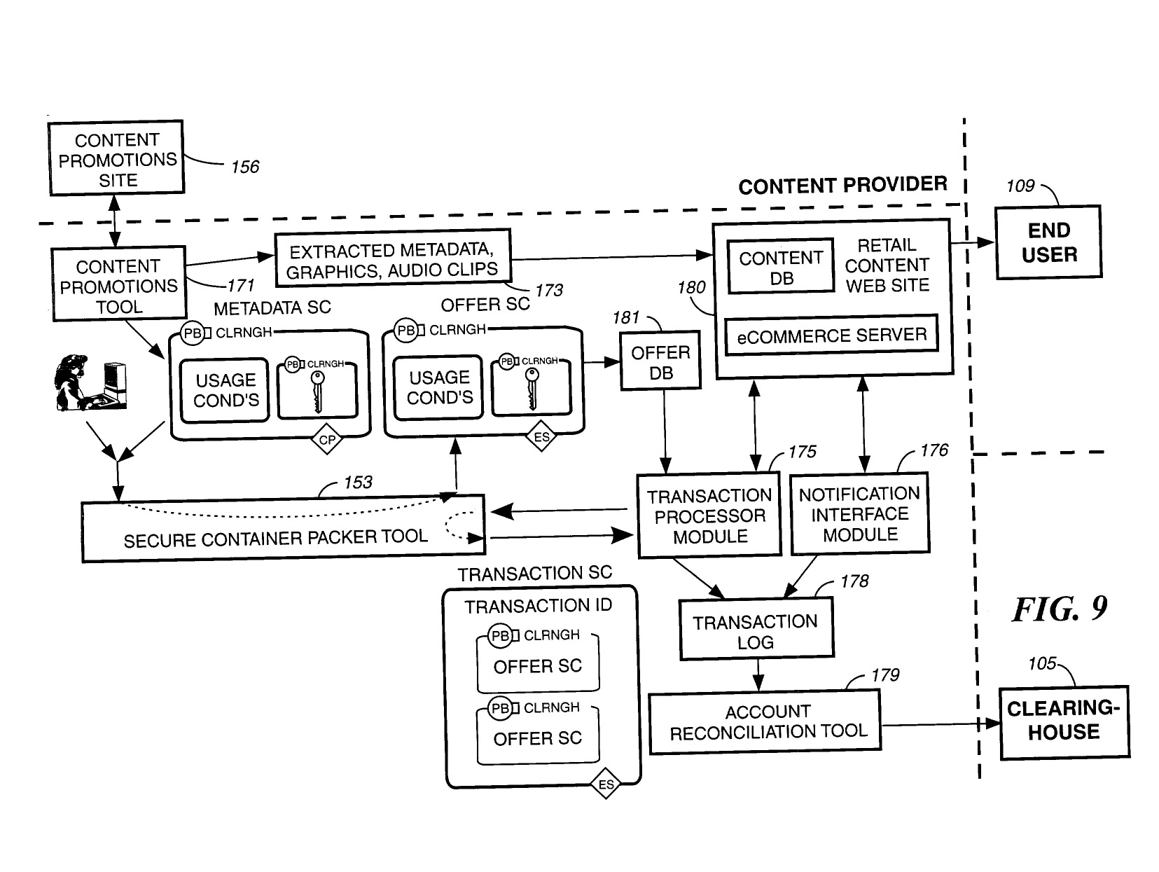

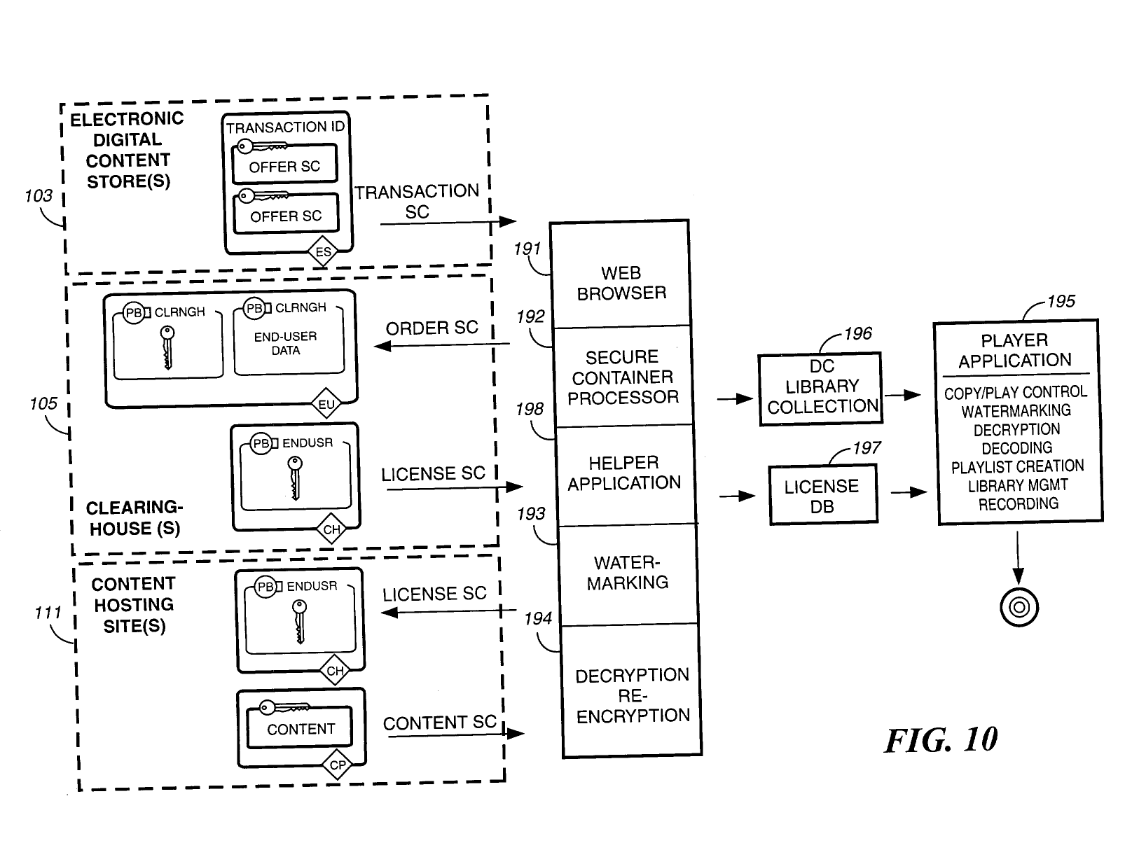

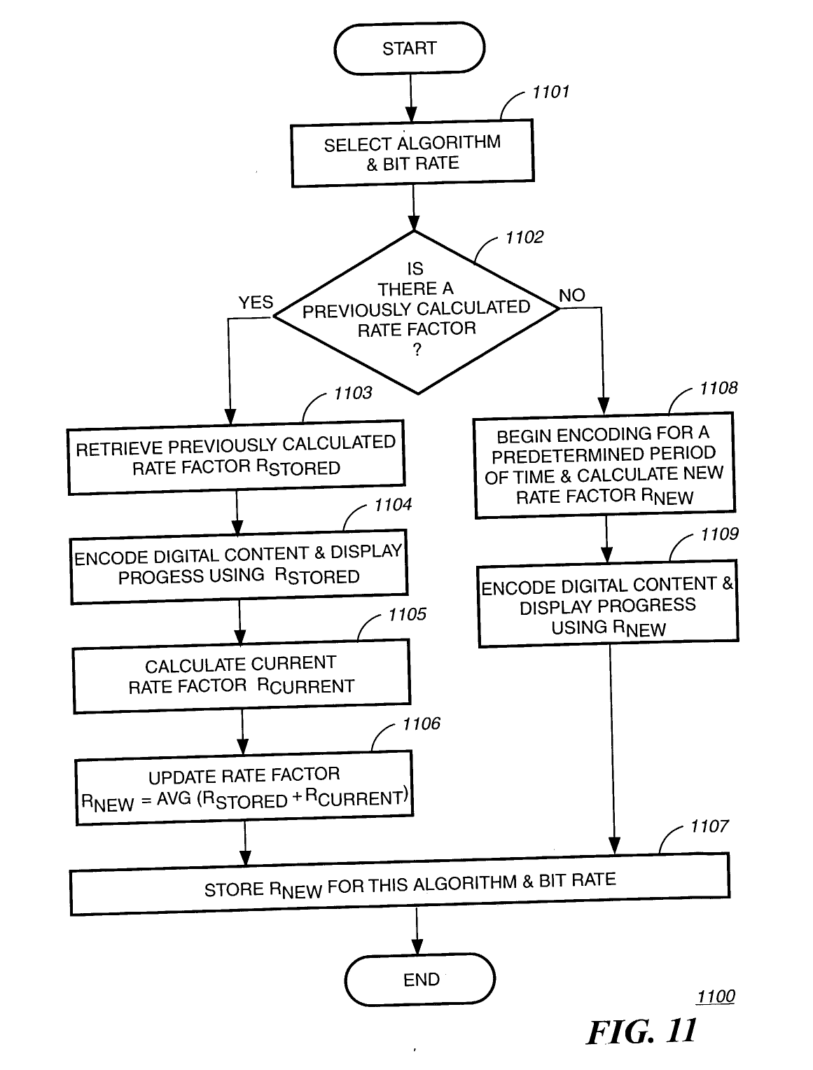

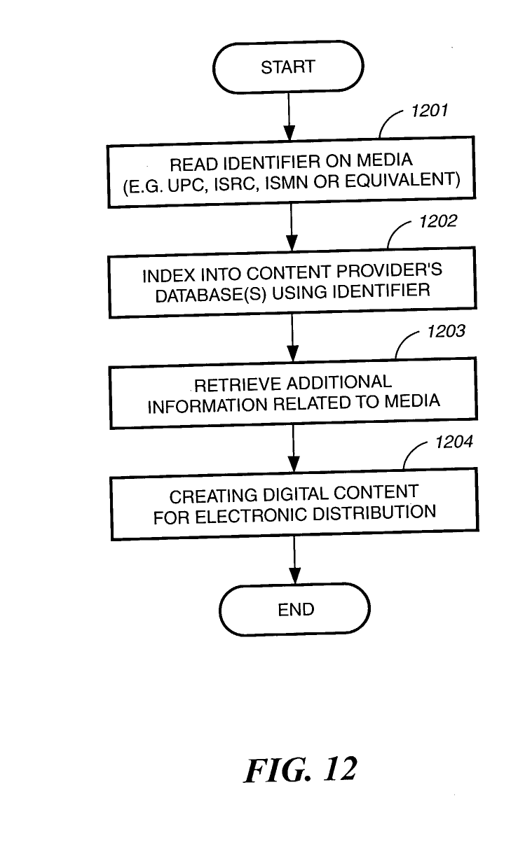

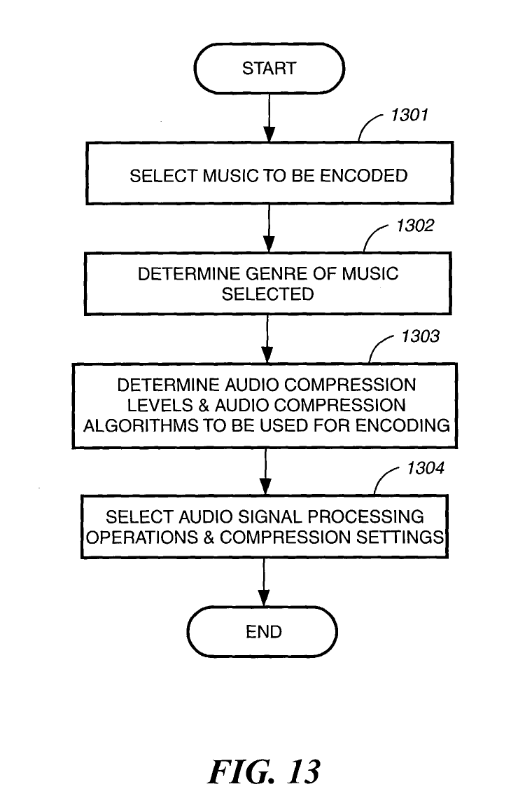

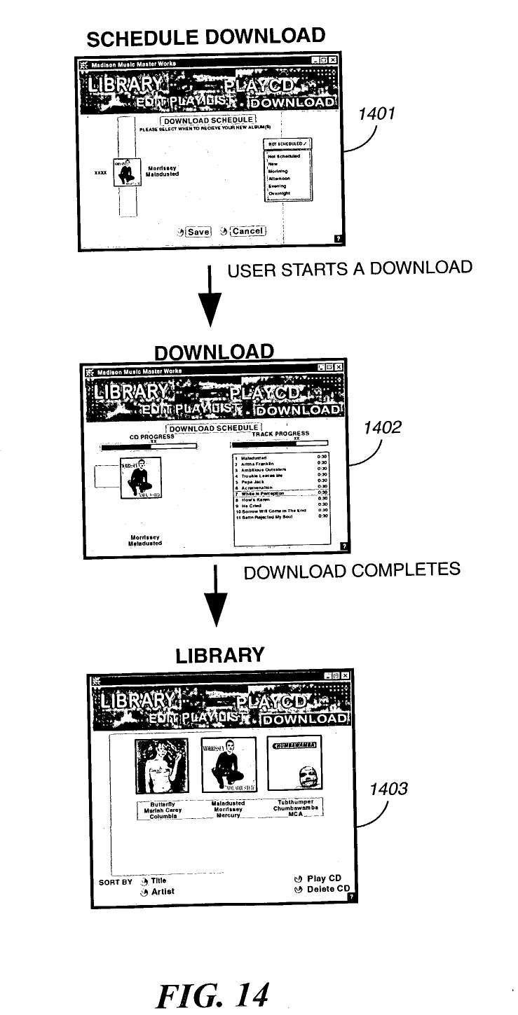

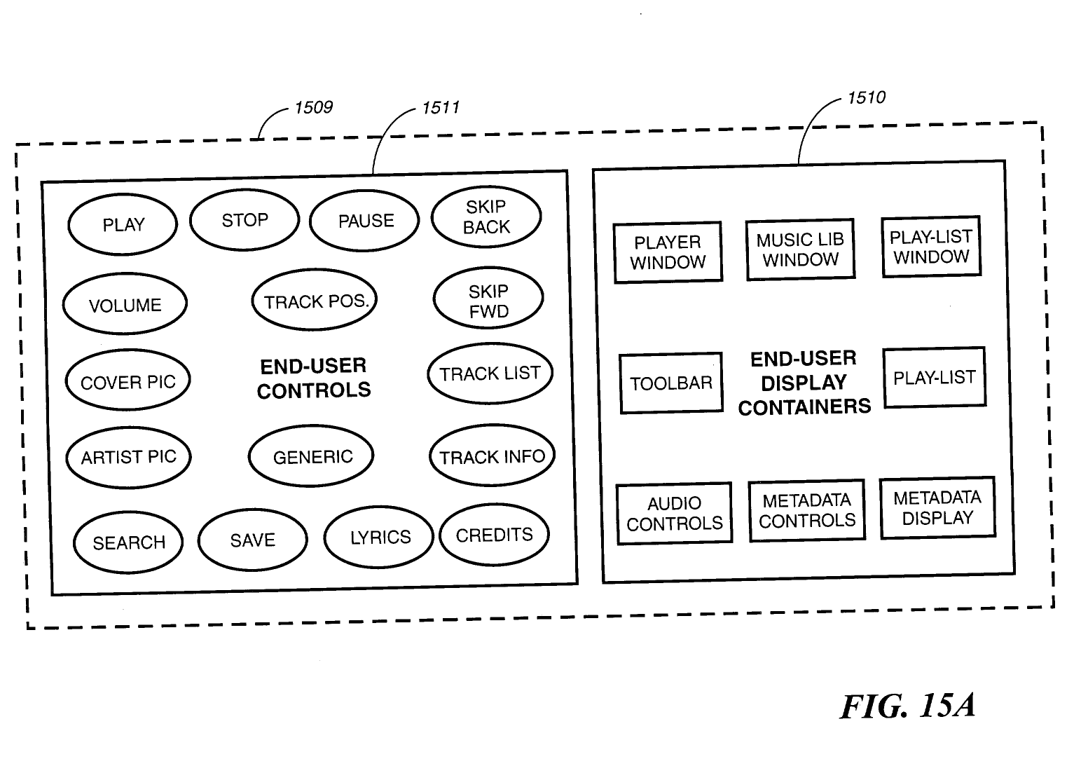

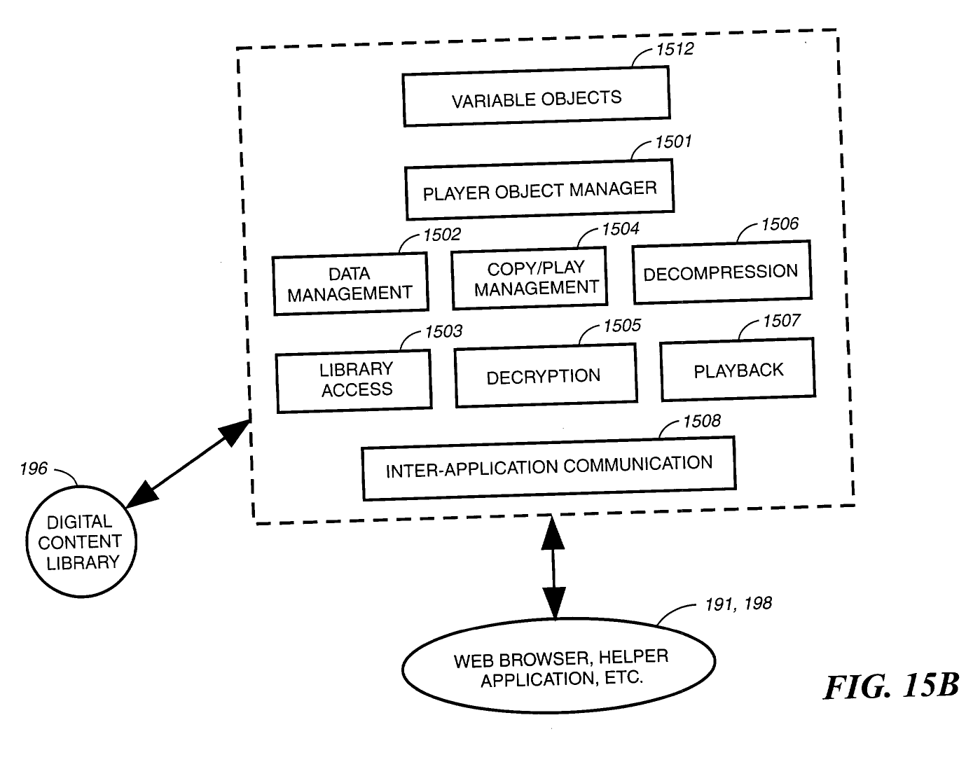

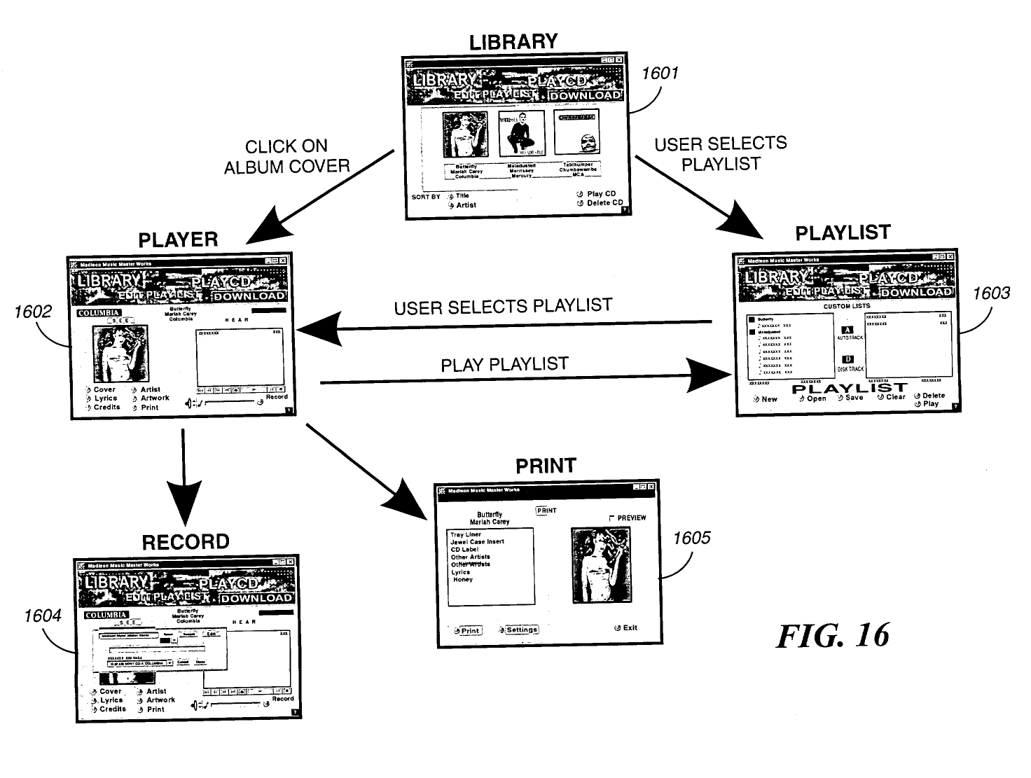

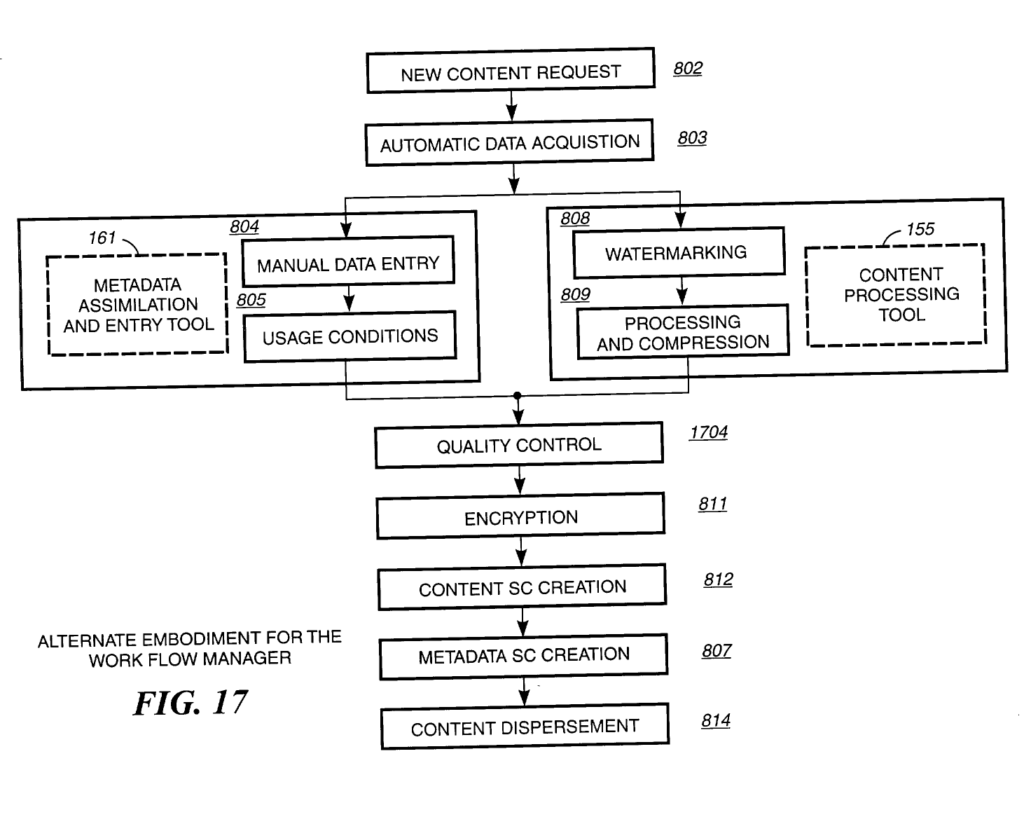

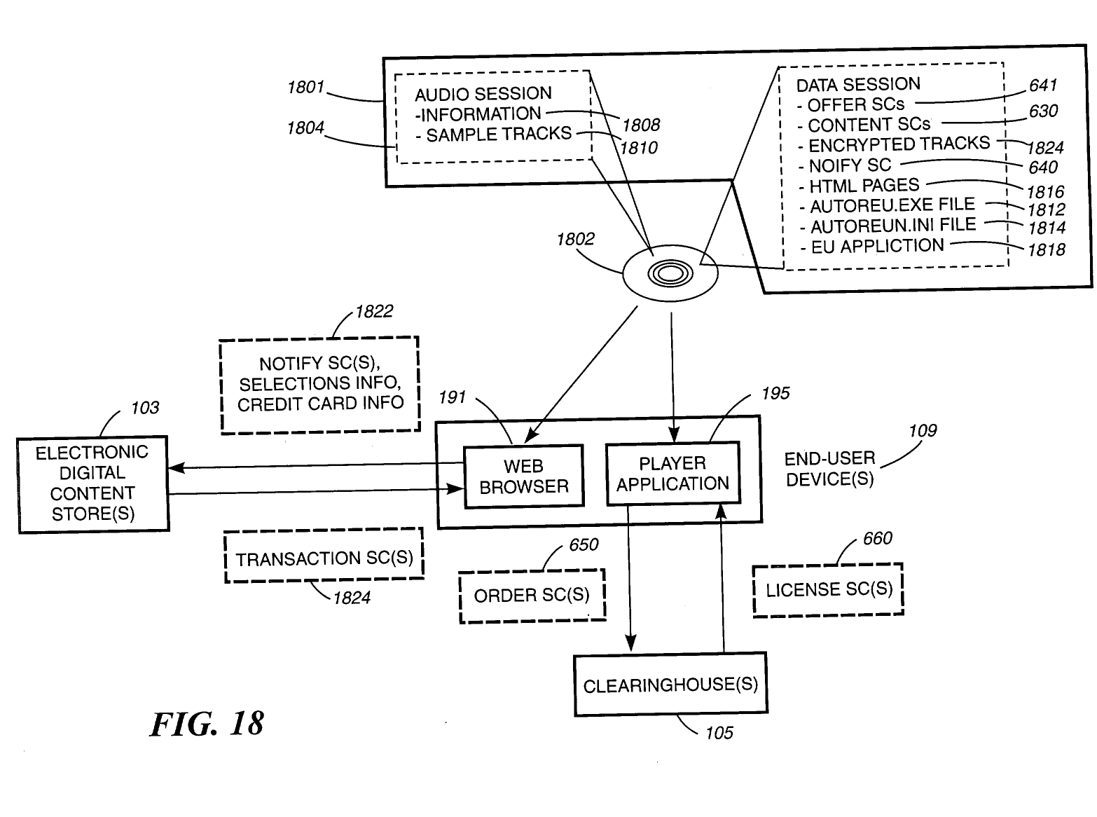

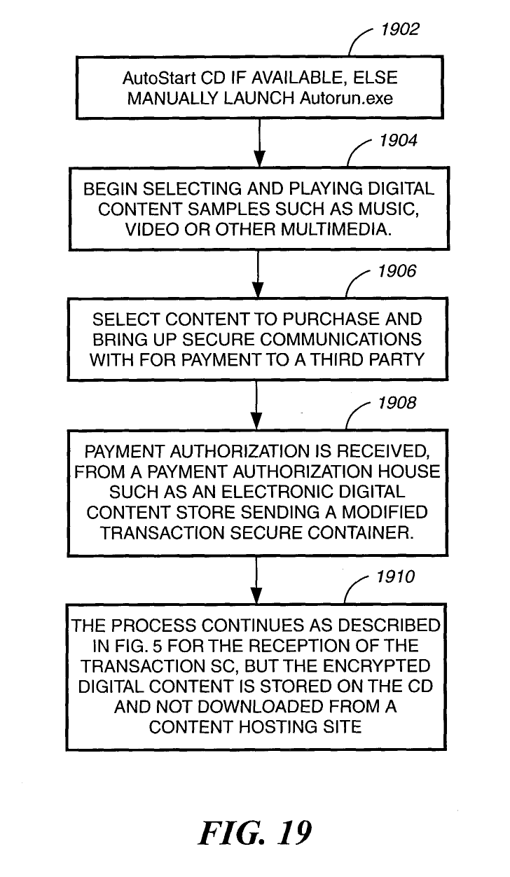

FIG. 9 is a block diagram of a computer system useful for implementing an embodiment of the present invention. The computer system of FIG. 9 is a more detailed representation of the computer 104 or the computer system of database 106. The computer system of FIG. 9 includes one or more processors, such as processor 904. The processor 904 is connected to a communication infrastructure 902 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 908 that forwards graphics, text, and other data from the communication infrastructure 902 (or from a frame buffer not shown) for display on the display unit 910. The computer system also includes a main memory 906, preferably random access memory (RAM), and may also include a secondary memory 912. The secondary memory 912 may include, for example, a hard disk drive 914 and/or a removable storage drive 916, representing a floppy disk drive, a magnetic tape drive, an optical disk drive, etc. The removable storage drive 916 reads from and/or writes to a removable storage unit 918 in a manner well known to those having ordinary skill in the art. Removable storage unit 918, represents, for example, a floppy disk, magnetic tape, optical disk, etc. which is read by and written to by removable storage drive 916. As will be appreciated, the removable storage unit 918 includes a computer usable storage medium having stored therein computer software and/or data.

In alternative embodiments, the secondary memory 912 may include other similar means for allowing computer programs or other instructions to be loaded into the computer system. Such means may include, for example, a removable storage unit 922 and an interface 920. Examples of such may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to the computer system.

The computer system may also include a communications interface 924. Communications interface 924 allows software and data to be transferred between the computer system and external devices. Examples of communications interface 924 may include a modem, a network interface (such as an Ethernet card), a communications port, a PCMCIA slot and card, etc. Software and data transferred via communications interface 924 are in the form of signals which may be, for example, electronic, electromagnetic, optical, or other signals capable of being received by communications interface 924. These signals are provided to communications interface 924 via a communications path (i.e., channel) 926. This channel 926 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 906 and secondary memory 912, removable storage drive 916, a hard disk installed in hard disk drive 914, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 906 and/or secondary memory 912. Computer programs may also be received via communications interface 924. Such computer programs, when executed, enable the computer system to perform the features of the present invention as discussed herein. In particular, the computer programs, when executed, enable the processor 904 to perform the features of the computer system. Accordingly, such computer programs represent controllers of the computer system.

VI. Conclusion

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method for translating data in a hierarchical data structure to a relational data structure, comprising:
reading a mapping script;
generating, in accordance with the script, a mapping for translating data from the hierarchical data structure to a relational data structure;
reading and traversing the hierarchical data using a tree traversal algorithm; and
translating the data of the hierarchical data structure to the relational data structure using the mapping.

2. The method of claim 1, wherein the hierarchical data structure includes a plurality of nodes, each node comprising a node identifier

3. The method of claim 2, wherein the tree traversal algorithm is a depth-first tree traversal algorithm.

4. The method of claim 1, wherein the second reading step comprises:
reading the node identifier and at least one of data and a pointer to one or more nodes, for each node of the plurality of nodes.

5. The method of claim 4, wherein the translating step comprises:
translating the data of the hierarchical data structure to the relational data structure using the mapping, wherein data of the hierarchical data structure is written in the relational data structure in accordance with the sequence of traversal of the plurality of nodes in the hierarchical data in the traversing step.

6. A method for translating data in a hierarchical data structure to a relational data structure, comprising:
manually generating a mapping for translating data from the hierarchical data structure to a relational data structure;
reading and traversing the hierarchical data using a tree traversal algorithm; and
translating the data of the hierarchical data structure to the relational data structure using the mapping.

7. The method of claim 6, wherein the hierarchical data structure includes a plurality of nodes, each node comprising a node identifier.

8. A computer readable medium comprising computer instructions for translating data in a hierarchical data structure to a relational data structure, the computer instructions including instructions for:
reading a mapping script;
generating, in accordance with the script, a mapping for translating data from the hierarchical data structure to a relational data structure;
reading and traversing the hierarchical data using a tree traversal algorithm; and
translating the data of the hierarchical data structure to the relational data structure using the mapping.

9. The computer readable medium of claim 8, wherein the hierarchical data structure includes a plurality of nodes, each node comprising a node identifier

10. The computer readable medium of claim 9, wherein the tree traversal algorithm is a depth-first tree traversal algorithm.

11. The computer readable medium of claim 8, wherein the second instructions for reading comprise:
reading the node identifier and at least one of data and a pointer to one or more nodes, for each node of the plurality of nodes.

12. The computer readable medium of claim 11, wherein the instructions for translating comprise:
translating the data of the hierarchical data structure to the relational data structure using the mapping, wherein data of the hierarchical data structure is written in the relational data structure in accordance with the sequence of traversal of the plurality of nodes in the hierarchical data in the traversing step.

13. A computer readable medium including computer instructions for translating data in a hierarchical data structure to a relational data structure, the computer instructions including instructions for:
manually generating a mapping for translating data from the hierarchical data structure to a relational data structure;
reading and traversing the hierarchical data using a tree traversal algorithm; and
translating the data of the hierarchical data structure to the relational data structure using the mapping.

14. The computer readable medium of claim 13, wherein the hierarchical data structure includes a plurality of nodes, each node comprising a node identifier

15. A computer system for translating data from a hierarchical data structure to a relational data structure, comprising:
a hierarchical data structure;
a relational data structure;
a mapping for translating data from the hierarchical data structure to the relational data structure, the mapping generated using a mapping script;
a hierarchical data abiding by a hierarchical structure for holding data; and
a translator for translating the hierarchical data abiding by the hierarchical data structure to the relational data structure using the mapping.

16. The computer system of claim 15, wherein the hierarchical data structure includes a plurality of nodes, each node comprising a node identifier.

17. The computer system of claim 16, wherein the tree traversal algorithm is a depth-first tree traversal algorithm.

18. The computer system of claim 19, wherein the translator translates the hierarchical data abiding by the hierarchical structure to the relational data structure using the mapping, wherein data of the hierarchical data structure is written in the relational data structure in accordance with a sequence of traversal of the plurality of nodes in the hierarchical data.

19. A computer system for translating data from a hierarchical data structure to a relational data structure, comprising:
a hierarchical data structure;
a relational data structure;
a mapping for translating data from the hierarchical data structure to the relational data structure, the mapping generated manually;
a hierarchical data abiding by a hierarchical structure for holding data; and
a translator for translating the hierarchical data abiding by the hierarchical data structure to the relational data structure using the mapping.

20. The computer system of claim 19, wherein the hierarchical data structure includes a plurality of nodes, each node comprising a node identifier.
